(19) United States
(12) Patent Application Publication
(10) Pub. No.: US 2025/0016643 A1
(43) Pub. Date: Jan. 9, 2025

(54) SYSTEMS AND METHODS FOR INTER-DONOR MIGRATION AND APPARATUS

(71) Applicant: ZTE Corporation, Shenzhen (CN)

(72) Inventors: Ying HUANG, Shenzhen (CN); Lin CHEN, Shenzhen (CN)

(73) Assignee: ZTE Corporation, Shenzhen (CN)

(21) Appl. No.: 18/888,870

(22) Filed: Sep. 18, 2024

Related U.S. Application Data
(63) Continuation of application No. PCT/CN2022/097410, filed on Jun. 7, 2022.

(51) Int. Cl. H04W 36/08; H04W 36/00; H04W 88/08

(52) U.S. Cl. CPC H04W 36/08; H04W 36/0061; H04W 88/08

(57) ABSTRACT

Presented are systems, methods, apparatuses, or computer-readable media for inter-donor migration and apparatus. A first network node may send information associated with an integrated access and backhaul (IAB) related migration to a second network node.

### CROSS-REFERENCE TO RELATED APPLICATION

This application claims the benefit of priority under 35 U.S.C. § 120 as a continuation of PCT Patent Application No. PCT/CN2022/097410, filed on Jun. 7, 2022, the disclosure of which is incorporated herein by reference in its entirety.

### TECHNICAL FIELD

The disclosure relates generally to wireless communications, including but not limited to systems and methods for inter-donor migration and apparatus.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for inter-donor migration and apparatus. A first network node may send/transmit/provide/signal/communicate information associated with an integrated access and backhaul (IAB) related migration to a second network node.

In some implementations, the first network node comprising a source donor can send the information to the second network node comprising a target donor. The information can comprise at least one of: an indication of distributed unit (DU) migration, a counter value of mobile termination (MT) migration procedures, or an identity of a third network node which has an F1 connection with an IAB-DU. In some implementations, the method can include determining (e.g., by the source donor or target donor) whether to perform DU or user equipment (UE) migration according to the information. The method can include sending an indication of whether to perform the DU or UE migration to the third network node.

In some implementations, the method can include determining whether to perform DU or user equipment (UE) migration by comparing the counter value to a threshold number of MT migration procedures (e.g., operations/procedures on/for MT migration). In some implementations, the threshold number of MT migration procedures can be sent to: at least one of the source donor or the target donor, or an IAB node.

In some implementations, the first network node comprising an IAB node or a source donor of an IAB-MT or a source donor of a user equipment (UE) can send the information to the second network node comprising a target donor. The information can comprise IP address request information or an indication of migration type. In some implementations, the method/apparatus/computer-readable-medium can involve at least one of: the IP address request information can comprise at least one of: a number of IP addresses for the IAB node, or an indicator of two sets of IP addresses; or the indication of migration type can comprise at least one of: partial migration, full migration, distributed unit (DU) migration, user equipment (UE) migration, or F1 transport migration.

In some implementations, the first network node can send the information via a radio resource control (RRC) message, an F1 application protocol (F1AP) message or an Xn application protocol (XnAP) message to the second network node. In some implementations, the first network node comprising a donor centralized unit (CU) can send information to the second network node comprising an IAB node. The information may comprise at least one of an F1 setup indication, which indicates to the IAB node to initiate an F1 setup procedure, a source logical DU indication, which indicates that the associated information is for a source logical DU, a target logical DU indication, which indicates that the associated information is for a target logical DU, a target donor IP address, which indicates an IP address of a target donor, a new IAB donor indication, which indicates that the associated information is for a new IAB donor, a type of migration type comprising at least one of: partial migration, full migration, distributed unit (DU) migration, user equipment (UE) migration, or F1 transport migration, or one or more backhaul adaptation protocol (BAP) addresses.

In some implementations, the first network node can send the information to the second network node via a radio resource control (RRC) message, or an F1 application protocol (F1AP) message. In some implementations, one of: the first network node comprising a first IAB donor can send the information to the second network node comprising a second IAB donor; or the first network node comprising an IAB node can send the information to the second network node comprising the second IAB donor.

In some implementations, the information may comprise at least one of: an identity of the IAB node, an identity of a target donor, an identity of a target cell, an indication of IAB mobile termination (IAB-MT) migration, an indication of IAB distributed unit (IAB-DU) migration, or an indication of user equipment (UE) migration. In some implementations, one of: the first network node comprising an IAB node can send the information to the second network node comprising a second IAB donor; or the first network node comprising a first IAB donor can send the information to the second network node comprising the second IAB donor; or the first network node comprising a target donor can send the information to the second network node comprising a source donor. The source donor may send the information to an initial donor. In some implementations, the information may comprise an old or source cell identifier (ID) of a distributed unit (DU) of the IAB node, and a new or target cell ID of the DU.

At least one aspect is directed to a system, a method, an apparatus, or a computer-readable medium for inter-donor migration and apparatus. A second network node can receive/obtain/retrieve/collect information associated with an integrated access and backhaul (IAB) related migration from a first network node.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and case of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram of an environment for a mobile integrated access and backhaul (IAB), in accordance with an illustrative embodiment;

FIG. 4A illustrates a block diagram of an integrated access and backhaul (IAB) architecture using standalone (SA) mode with a next generation core (NGC), in accordance with an illustrative embodiment;

FIG. 4B illustrates a block diagram of an integrated access and backhaul (IAB) architecture using Evolved Universal Mobile Telecommunications System New Radio (EN-DC), in accordance with an illustrative embodiment;

FIG. 5 illustrates a block diagram of integrated access and backhaul (IAB) nodes in a parent and child relationship, in accordance with an illustrative embodiment;

FIG. 6A illustrates a block diagram of an integrated access and backhaul (IAB) mobile termination (MT) migrating from a first donor distributed unit (DU1) of a first centralized unit (CU1) to a second donor distributed unit (DU2) of a second donor centralized unit (CU2), in accordance with an illustrative embodiment;

FIG. 6B illustrates a block diagram of an integrated access and backhaul (IAB) mobile termination (MT) migrating from a second donor distributed unit (DU2) of a second donor centralized unit (CU2) to a third donor distributed unit (DU3) of a third donor centralized unite (CU3), in accordance with an illustrative embodiment;

FIG. 6C illustrates a block diagram of an integrated access and backhaul (IAB) distributed unit (DU) migrating from a first donor centralized unit (CU1) to a third donor centralized unit (CU3), in accordance with an illustrative embodiment; and

FIG. 7 illustrates of a flow diagram of a method for inter-donor migration and apparatus, in accordance with an illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

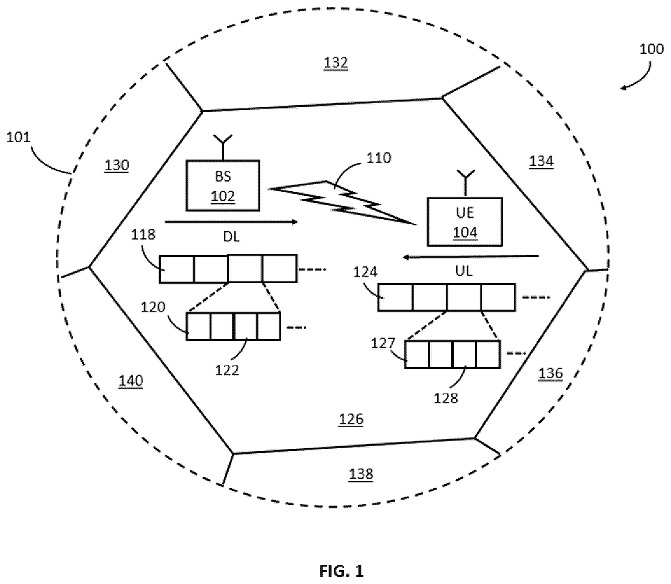

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

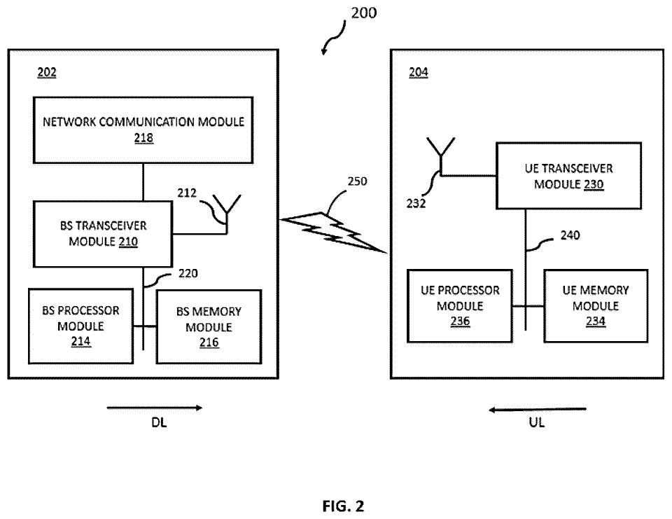

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Inter-Donor Migration and Apparatus

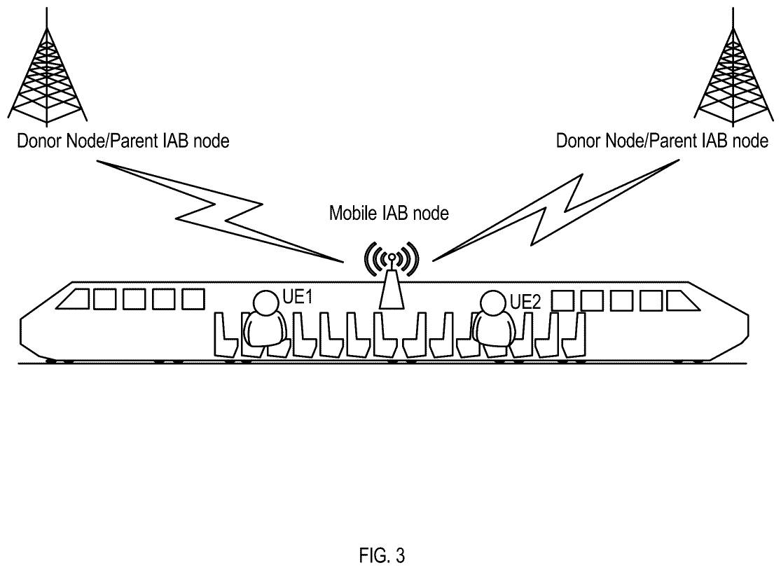

Referring now to FIG. 3, depicted is a block diagram of an environment for a mobile integrated access and backhaul (IAB). An Integrated Access and Backhaul (IAB) may support wireless backhauling via new radio (NR) enabling flexible and very dense deployment of NR cells while reducing the need for wireline transport infrastructure. Intra-donor centralized unit (CU) migration procedure may be provided in which both the source and the target parent node are served by the same IAB-donor-CU. The inter-donor CU migration in the migrating (mobile) IAB node, however, may be static. It may be difficult to perform inter-donor migration in a mobile IAB use scenario as depicted. In a mobile IAB use case, IAB nodes are mounted in vehicles and can provide coverage and capacity enhancement to onboard or surrounding user equipment (UEs).

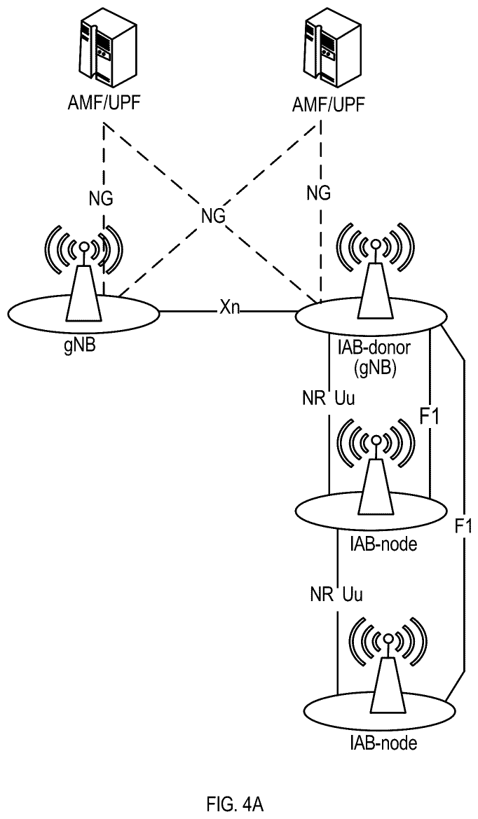

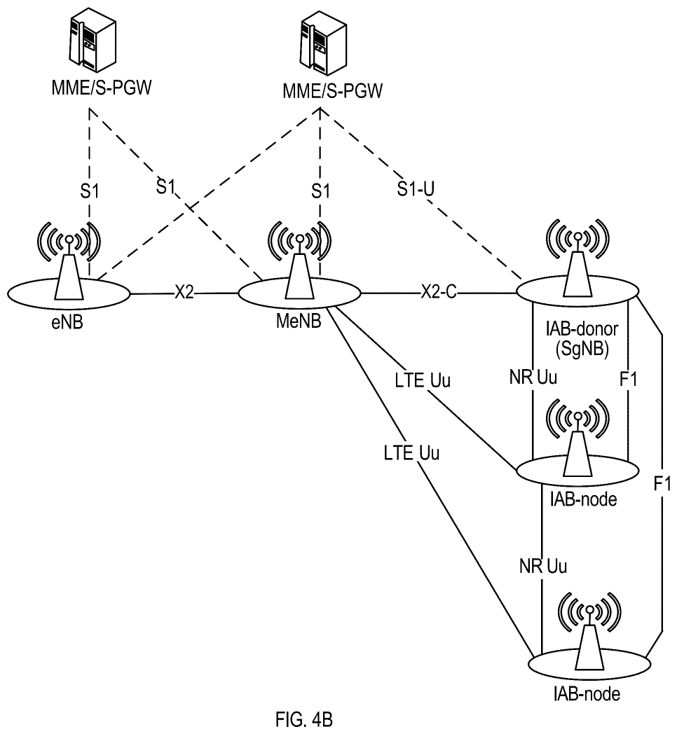

Referring now to FIG. 4A, depicted is a block diagram of an integrated access and backhaul (IAB) architecture using standalone (SA) mode with a next generation core (NGC). The integrated access and backhaul (IAB) can enable wireless relaying in NG-RAN. The relaying node, referred to as IAB-node, may support access and backhauling via NR. The terminating node of NR backhauling on network side may be referred to as the IAB-donor, which can represent a gNB with additional functionality to support IAB. Backhauling can occur via a single or via multiple hops.

The IAB-node may support gNB-DU functionality, to terminate the NR access interface to UEs and next-hop IAB-nodes, and/or to terminate the F1 protocol to the gNB-CU functionality, on the IAB-donor. The gNB-DU functionality on the IAB-node may be also referred to as IAB distributed unit (DU) (IAB-DU). In addition to the gNB-DU functionality, the IAB-node may also support a subset of the UE functionality referred to as IAB-mobile termination (MT), which includes, e.g., physical layer, layer-2, radio resource control (RRC) and non-access stratum (NAS) functionality to connect to the gNB-DU of another IAB-node or the IAB-donor, to connect to the gNB-CU on the IAB-donor, and to the core network, among others.

Referring now to FIG. 4B, depicted is a block diagram of an integrated access and backhaul (IAB) architecture using Evolved Universal Mobile Telecommunications System New Radio (EN-DC). The IAB-node can access the network using either SA-mode or EN-DC. In EN-DC, the IAB-node also connects via E-UTRA to a MeNB, and the IAB-donor terminates X2-C as SgNB (e.g., as defined in TS 37.340).

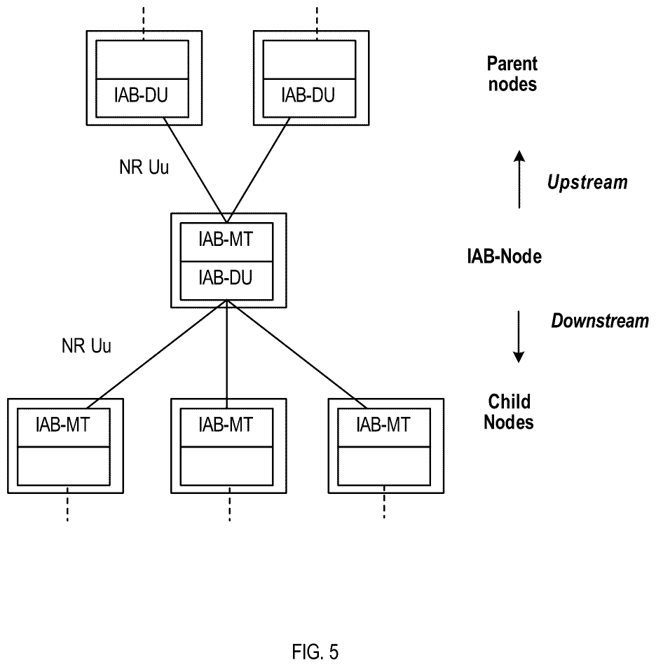

Referring now to FIG. 5, depicted is a block diagram of integrated access and backhaul (IAB) nodes in a parent and child relationship. All IAB-nodes that are connected to an IAB-donor via one or multiple hops can form a directed acyclic graph (DAG) topology with the IAB-donor at its root. In this DAG topology, the neighbor node on the IAB-DU's interface may be referred to as child node and the neighbor node on the IAB-MT's interface is referred to as parent node. The direction toward the child node may be further referred to as downstream while the direction toward the parent node is referred to as upstream. The IAB-donor may perform centralized resource, topology and route management for the IAB topology.

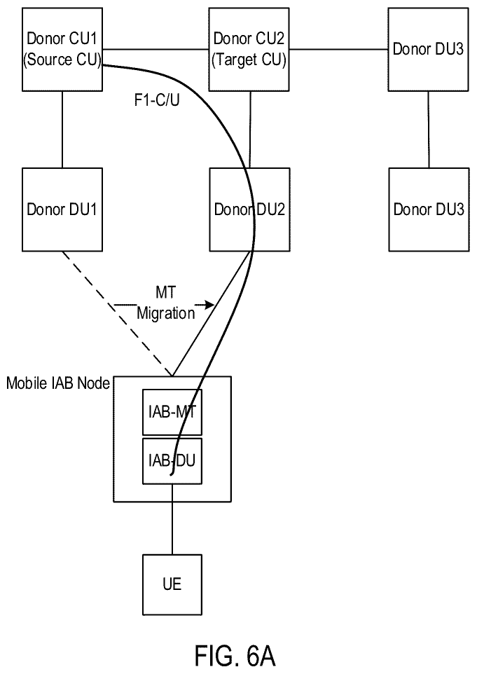

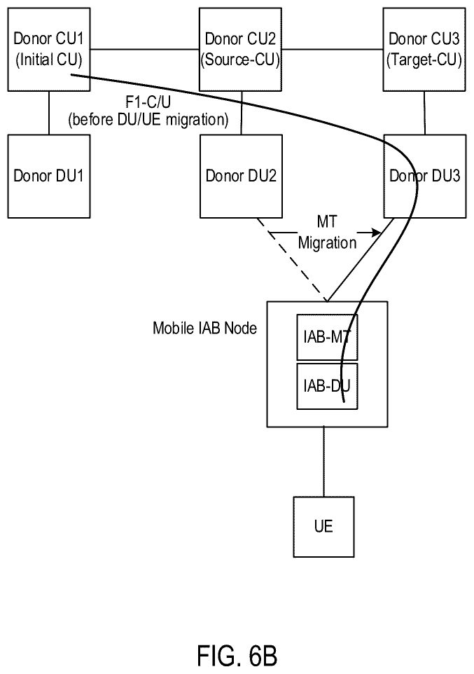

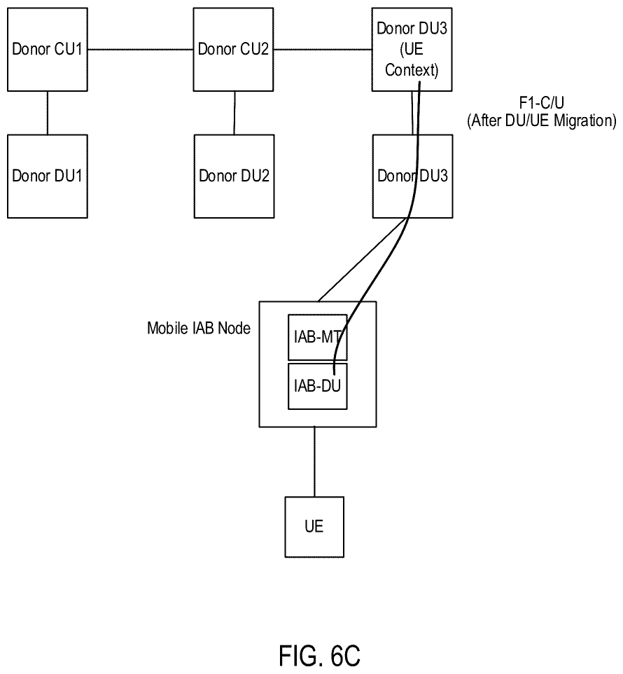

Referring to FIG. 6A, depicted is a block diagram of an integrated access and backhaul (IAB) mobile termination (MT) migrating from a first donor distributed unit (DU1) of a first centralized unit (CU1) to a second donor distributed unit (DU2) of a second donor centralized unit (CU2). As depicted, the mobile IAB-MT may migrate from donor DU1 (which belongs to donor CU1) to donor DU2 (which belongs to donor CU2). The mobile IAB-DU, however, may maintain its F1 connection with donor CU1, and UE context can remain in/with the donor CU1. F1-C/U traffic between donor CU1 and mobile IAB-DU may be transmitted via donor DU2.

Referring to FIG. 6B, depicted is a block diagram of an integrated access and backhaul (IAB) mobile termination (MT) migrating from a second donor distributed unit (DU2) of a second donor centralized unit (CU2) to a third donor distributed unit (DU3) of a third donor centralized unite (CU3). As depicted, mobile IAB-MT may migrate from donor DU2 (which belongs to donor CU2) to donor DU3 (which belongs to donor CU3). The mobile IAB-DU, however, may maintain its F1 connection with donor CU1, and UE context can remain in/with donor CU1. F1-C/U traffic between donor CU1 and mobile IAB-DU may be transmitted via donor DU3.

Referring to FIG. 6C, depicted is a block diagram of an integrated access and backhaul (IAB) distributed unit (DU) migrating from a first donor centralized unit (CU1) to a third donor centralized unit (CU3). As depicted, the mobile IAB-DU may migrate from donor CU1 to donor CU3. The UE may be handed over (or undergo handover/migration/switching) from donor CU1 to donor CU3. F1-C/U traffic between donor CU3 and mobile IAB-DU may be transmitted via donor DU3.

As depicted in FIGS. 6A-C, the respective donor CU can be associated with or correspond to at least one of a source IAB donor, target IAB donor, or an initial IAB donor. For example, the source IAB donor can represent a donor including a donor DU previously connected to or in communication with the mobile IAB-MT or the UE 104. The target IAB donor can represent a donor CU that the mobile IAB-MT or the UE migrated to. The initial IAB donor can represent the at least one IAB donor having F1-C connection with the mobile IAB-node, or one IAB donor which is the source IAB donor of the UE, or one IAB donor which is serving the UE 104 (e.g., gNB, BS 102, or donor CU serving the UE 104). Hereinafter, the mobile IAB node and/or mobile IAB-DU may sometimes be referred to generally as IAB node and/or IAB-DU, respectively.

### I. Implementation 1: Determine Whether to Perform DU/UE Migration

In various implementations, the DU (e.g., IAB-DU) migration and/or UE 104 migration may be performed subsequent to or after, or before IAB-MT migration. The IAB-MT and IAB-DU can be a part of an IAB entity (e.g., donor or node) (e.g., BS 102, gNB, or network node). Because the DU/UE migration may be performed before or after the IAB-MT migration, it can be challenging to determine who (e.g., which network node) and how (e.g., operations, methods, or procedures) to perform the DU migration and/or UE migration (e.g., DU/UE migration). The DU migration may refer to the migration of the IAB-DU. The UE migration may refer to the migration of the UE 104. The systems and methods discussed herein can determine at least one IAB entity (e.g., network node) to determine whether to perform the DU/UE migration and/or how the IAB entity trigger the DU/UE migration. The determination of who and how to trigger the DU/UE migration can be based on or according to the number of IAB-MT migration procedures/operations (e.g., how many MT migration(s) have been performed by the IAB node and/or the IAB-DU) performed after a previous migration of the co-located IAB-DU (e.g., the IAB-DU being co-located with the IAB-MT in the IAB node). Hence, based on the number of IAB-MT migrations, the IAB-DU can determine/decide whether to perform the DU/UE migration. In various embodiments, the first, second, or third, among other network nodes can be described as or correspond to an IAB node or IAB donor, based on the examples/contexts detailed herein.

For example, a source donor (e.g., source CU or a first network node, such as shown in conjunction with at least one of FIGS. 6A-C) can transmit/send/provide/signal MT migration-related information (e.g., included/contained in the historical information of the UE 102) to a target donor (e.g., target CU of a second network node). The MT migration-related information can include at least one of the following:
1) An indication/flag of DU migration. The DU migration indication can indicate that the DU/UE migration is performed when (e.g., occurrences or timeframes) the co-located IAB-MT of the IAB node migrates from or to the corresponding cell (e.g., the cell associated with the source donor);
2) A counter (e.g., counter value) of IAB-MT migration procedures. The counter value can increase by one (e.g., among other preconfigured incremental values) before/during/after the IAB-MT migration performed by the source donor and/or target donor of the IAB-MT. The counter value may be reset to zero before/during/after the migration of the co-located IAB-DU; and/or
3) Identity of the initial IAB donor (e.g., third network node). The initial IAB donor can include an F1 connection with the IAB-DU, for example. The identity of the initial donor can include or correspond to gNB-ID, among other identities.

Responsive to transmitting and/or receiving the information (e.g., MT migration-related information) from the source donor, the source donor and/or target donor associated with the IAB-MT can determine whether to perform DU/UE migration. For example, the source and/or target donor can compare the counter value to a threshold (e.g., a threshold number of MT migration procedures performed). The threshold can be determined/configured based on the implementations, such as set to 2, 3, 4, or other threshold values. The threshold may be configured via an operations, administration, and maintenance (OAM) signaling to one or more IAB nodes or IAB donors, for example. If the counter value is greater than or equal to the threshold, the source and/or target donor can transmit/send/provide/signal a DU/UE migration indication to the initial donor.

In a further example, referring to FIGS. 6A-C, the threshold number may be configured as two. The counter value may be increased (e.g., by at least one of the IAB entity) responsive to the MT migration(s). When the IAB-MT migrates to Donor DU3, the counter value can be increased to two, which equals to the threshold. Accordingly, the source and/or target donor receiving the information can determine to perform the DU/UE migration according to the counter value being greater than or equal to the threshold.

In some cases, the threshold number of MT migration procedures can be coordinated/communicated between the donor CUs (e.g., between the first, second, and/or third donor CUs, etc.) via XnAP signaling. For example, at least one donor CU can transmit an indication of the threshold to one or more other donor CUs via a handover request or retrieve UE context response message. This message can be sent along with or as part of the historical information of the UE. The threshold number of MT migration procedures can be configured/updated/provided to the IAB node via RRC and/or F1AP signaling.

### II. Implementation 2: Determine a Migration Type to Perform for IAB Node Migration

In various implementations, there can be different types of migration procedures/operations, such as partial migration, full migration, DU migration, UE migration, F1 transport migration, among others. Hence, in these implementations, the IAB donor (e.g., target donor or target CU) need to be informed/notified or made aware of the migration type of the IAB node migration to be performed.

For example, the target donor (e.g., of second network node) can receive/obtain IAB migration-related information from at least one of the IAB node or another IAB-CU (e.g., the source CU or the initial CU) (e.g., first network node). The IAB migration-related information can include at least one of the following information:
1) IP address request information (e.g., operating as an implicit indication). The IP address request information can include at least one of a number of IP addresses for the IAB node and/or an indicator of two sets of IP addresses. The indicator of the two sets of IP addresses may indicate that two sets of IP addresses are required (or not required). For instance, a request for two sets of IP addresses may be an indication to perform at least one of a full migration procedure, DU migration procedure, and/or UE migration procedure, among other migration types.
2) An indication of migration type (e.g., operating as an explicit indication). This indication can include or be used to indicate the type of the migration, such as at least one of: partial migration, full migration, DU migration, UE migration, and/or F1 transport migration, among others. Partial migration can include the migration/handover/switching of an IAB-MT to a parent node underneath or associated with a different IAB-donor-CU while the collocated IAB-DU and/or descendant IAB-node(s) (e.g., if any) can terminate at the initial IAB-donor-CU. Full migration can include the migration of the boundary IAB node and/or the descendant IAB node(s) (e.g., both RRC and F1 connection) to a second IAB donor CU from a first IAB donor CU. DU migration can include the migration of IAB-DU from one IAB donor to another IAB donor. UE migration can include the migration of the UE 104 from one radio access network (RAN) node to another RAN node. F1 transport migration can include the migration of the transport path of F1 traffic from one path to another path.

In some cases, the IAB node (e.g., first network node) can transmit/send the IAB migration-related information to the target donor via a radio resource control (RRC) message and/or a F1 application protocol (F1AP) message. In some other cases, another IAB-CU (e.g., of a first network node) can transmit the IAB migration-related information to the target donor via an XnAP message (e.g., XnAP handover request or IAB transport migration management request message).

### III. Implementation 3: Inform IAB Node of DU/UE Migration

In various implementations, various types of migration procedures may be presented, such as partial migration, full migration, DU migration, UE migration, F1 transport migration, among others. Therefore, the IAB node need to be informed/notified/instructed/triggered (e.g., via specific signaling) to perform/initiate/proceed with DU/UE migration.

For example, the IAB node (e.g., second network node) can receive IAB-related configuration information from the donor CU (e.g., source donor, target donor, initial donor, and/or other IAB-donors) via RRC and/or F1AP signaling. The IAB related configuration information can include at least one of the following:
1) An F1 setup indication. This indication can indicate to the IAB node to initiate an F1 setup procedure/operation;
2) An F1 switch indication. This indication can indicate to the IAB node to initiate an F1 switch procedure/operation;
3) A source logical DU indication. This indication can indicate that the associated information (e.g., IAB-related configuration information) is for a source logical DU (e.g., there may be multiple logical DUs in the IAB node, such as source logical DU, target logical DU, etc.);
4) A target logical DU indication. This indication can indicate that the associated information is for, is applicable to, or belongs to a target logical DU;
5) A target donor (e.g., target CU) IP address. This IP address can indicate or represent the IP address of the target donor;
6) A new IAB donor indication. This indication can indicate that the associated information is for a new IAB donor (e.g., a third network node or another network node);
7) A migration type indication. This indication can indicate the type of the migration (e.g., migration type) to be performed, such as at least one of: partial migration, full migration, DU migration, UE migration, and/or F1 transport migration; and/or
8) One or more backhaul adaptation protocol (BAP) addresses. The one or more BAP addresses can be allocated by the donor CU to the IAB node, such as one BAP address for each logical DU.

### IV. Implementation 4: Trigger DU/UE Migration at the Initial Donor CU

In various implementations, different types of migration procedures may be presented/introduced, such as partial migration, full migration, DU migration, UE migration, F1 transport migration, among others. As such, there may be different procedures/operations/alternatives to triggering DU/UE migration, for example, at the initial donor (e.g., initial CU connected to or in communication with the IAB-DU). One or more of the following operations or procedures can be performed.

### A) Triggered by Source Donor (e.g., Source CU) of IAB-MT

In some cases, the DU/UE migration can be triggered by the source donor associated with or in communication with the IAB-MT. For example, the source donor (e.g., first network node or first IAB donor) can transmit/send/provide IAB-related information to the initial IAB donor (e.g., second network node or second IAB donor). In this case, the IAB-related information can include at least one of the following:
1) Identity of the IAB node;
2) Identity of the target IAB donor (e.g., target donor or target CU);
3) Identity of a target cell (e.g., cell associated with the target donor);
4) An indication of IAB-MT migration (also sometimes referred to as MT migration);
5) An indication of IAB-DU migration; and/or
6) An indication of UE migration.

### B) Triggered by Target Donor (e.g., Target CU) of IAB-MT

Additionally or alternatively, the DU/UE migration can be triggered by the target donor of the IAB-MT. For example, the target donor (e.g., target CU of a first network node or a first IAB donor) can send/transmit IAB-related information to the initial IAB donor (e.g., second network node or second IAB donor). The IAB-related information can include at least one of the following:
1) Identity of the IAB node;
2) Identity of the target cell;
3) An indication of IAB-MT migration;
4) An indication of IAB-DU migration; and/or
5) An indication of UE migration.

### C) Triggered by IAB Node

Further, additionally or alternatively, the DU/UE migration can be triggered by the IAB node. For example, the IAB node (e.g., first network node) can send IAB-related information to the initial IAB donor (e.g., second network node). In this case, the IAB-related information can include at least one of the following:
1) Identity of the target IAB donor;
2) Identity of the target cell;
3) An indication of IAB-MT migration;
4) An indication of IAB-DU migration; and/or
5) An indication of UE migration.

### V. Implementation 5: Determine New/Target Cell ID of IAB-DU Cell Serving the UE

In various implementations, the initial donor (e.g., initial CU) may send/transmit/signal an Xn handover request message to the target donor (e.g., target CU) to initiate the migration procedure for one or more UEs 104. The target cell identity/identifier (ID) may be included in the Xn handover request message. However, the initial donor may not be aware of the new/target cell ID of IAB-DU cell serving the UEs 104. Hence, one or more IAB entities (e.g., IAB node and/or another IAB donor) can inform/indicate/signal the initial donor of the new/target cell ID.

For example, the IAB node (e.g., first network node comprising an IAB node) can send/transmit information including the old/source cell ID and/or corresponding new/target cell ID of the IAB-DU (e.g., DU of the IAB node) to the initial donor (e.g., second network node comprising a second IAB donor). The IAB node can transmit the information via RRC and/or F1AP. Additionally or alternatively, the target donor (e.g., target CU or first network node comprising a first IAB donor) can send the information (e.g., old and/or corresponding new/target cell ID of the IAB-DU) to the initial donor CU.

Additionally or alternatively, the target donor (e.g., target CU or first network node comprising a target donor) can send the information (e.g., the old and corresponding new/target cell ID of the IAB-DU) to the source donor (e.g., source CU or second network node comprising a source donor). In this case, the source donor can send/forward the information to the initial donor (e.g., third network node comprising the initial donor). Based on the information transmitted, received, or communicated between one or more IAB entities (e.g., IAB node(s) and/or IAB donor(s)), the DU/UE migration procedures can be performed accordingly.

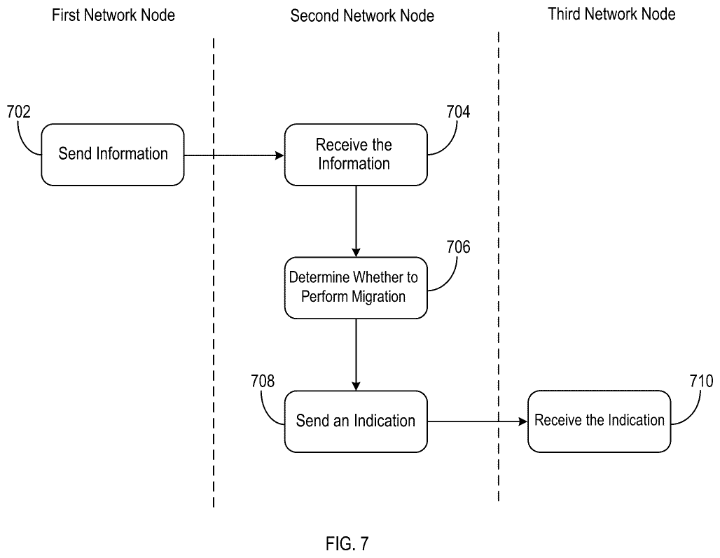

Referring now to FIG. 7, depicted is a flow diagram of a method 700 of inter-donor migration and apparatus. The method 700 may be implemented using or performed by any of the components detailed above, such as the UE 104 or 204 and BS 102 or 202, among others. In overview, a first network node (e.g., a network entity, such as an IAB node or IAB donor) can send information (702). A second network node (e.g., another network entity, such as another/different IAB donor or IAB node) can receive the information (704). The second network node can determine whether to perform migration (e.g., DU/UE migration procedure) (706). The second network node can send an indication (708). A third network node can receive the indication (710).

In further detail, a first network node (e.g., a network entity, communication node, BS, or gNB) may send/provide/transmit/signal information to a second network node (702). The first network node, the second network node, and/or the third network node can include/comprise one of an IAB node or an IAB donor, and may be used interchangeably to describe another IAB entity described herein. The information may be associated with an IAB-related migration. The second network node can receive the information from the first network node (704).

In some implementations, the first network node can include a source donor. The first network node can send/transmit/provide the information to the second network node comprising a target donor. The information can include at least one of: an indication of DU migration, a counter value (e.g., indicating the number of times/occurrences, or a count of occurrences) of MT migration procedures, and/or an identity (ID) of a third network node which has an F1 connection with an IAB-DU.

In various implementations, the first network node can include an IAB node or a source donor of an IAB-MT or a source donor of a UE (e.g., communication device). The first network node can send information to the second network node. The second network node can include a target donor (e.g., target donor CU). The information can include at least one of IP address request information and/or an indication of migration type. The IP address request information can include at least one of: a number of IP addresses for the IAB node, and/or an indicator of two sets of IP addresses. The migration type indication can include at least one of: partial migration, full migration, distributed unit (DU) migration, user equipment (UE) migration, and/or F1 transport migration. In some embodiments, the first network node can send the information to the second network node via a radio resource control (RRC) message, an F1 application protocol (F1AP) message, and/or an Xn application protocol (XnAP) message.

In some implementations, the first network node may include or correspond to a donor CU. The second network node may include or correspond to an IAB node. The first network node can transmit/send information to the second network node comprising an IAB node. In this case, the information can include at least one of: an F1 setup indication indicating to the IAB node to initiate an F1 setup procedure, a source logical DU indication indicating that the associated information is for a source logical DU, a target logical DU indication indicating that the associated information is for a target logical DU, a target donor IP address indicating an IP address of a target donor, a new IAB donor indication indicating that the associated information is for a new IAB donor, a type of migration type, which can include at least one of: partial migration, full migration, distributed unit (DU) migration, user equipment (UE) migration, or F1 transport migration, and/or one or more backhaul adaptation protocol (BAP) addresses. In some aspects, the first network node can send the information to the second network node via an RRC message and/or an F1AP message.

In some cases, the first network node can include a first IAB donor. The first node can send information to the second network node, which can include a second IAB donor. In some cases, the first network node can include an IAB node. The first network node can send information to the second network node, which can include the second IAB donor. In one or more of these cases, the information can include at least one of: an identity of the IAB node, an identity of a target donor, an identity of a target cell, an indication of IAB-MT migration, an indication of IAB-DU migration, and/or an indication of UE migration.

In some aspects, the first network node can include an IAB node. The first network node can send information to the second network node, which can include a second IAB donor. In some other aspects, the first network node can include a first IAB donor. The first network node can send information to the second network node, which can include the second IAB donor. In yet other aspects, the first network node can include a target donor. The first network node can send information to the second network node, which can include a source donor. In this case, the source donor may send the information to an initial donor (e.g., the second IAB donor or another (e.g., third) network node including the initial donor). In one or more of these cases, the information can include an old or source cell identifier (ID) of a DU of the IAB node, and/or a new or target cell ID of the DU.

After receiving the information, the second network node (e.g., including one of the source donor or target donor) can determine whether to perform DU or UE (e.g., DU/UE) migration according to the information (706). For example, the information may include a counter value indicating the number of MT migration procedure(s) performed. The second network node (and/or other network nodes) can compare the counter value to a threshold (or defined) number of MT migration procedures (e.g., MT migration occurrences). By comparing the counter value to the threshold number, the second network node can determine whether to perform DU/UE migration.

For example, the second network node can determine to perform the DU/UE migration based on the counter value being greater than or equal to the threshold number. The second network node can determine not to perform the DU/UE migration based on the counter value less than the threshold number, or vice versa according to certain implementations. In some implementations, the threshold number of MT migration procedures may be sent/transmitted/provided to at least one of the source donor, the target donor, and/or the IAB node.

Based on the determination, the second network node (e.g., source donor or target donor) can send an indication/message to a third network node on whether to perform the DU or UE migration (708). The third network node (e.g., the initial donor or another donor which has an F1 connection with the IAB-DU of the IAB node) can receive the indication from the second network node (710). Accordingly, the third network node (and/or one or more other network nodes) can perform the DU or UE migration based on the information communicated to, from, or between one or more network nodes.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one or more embodiments/implementations can be combined with one or more features of another embodiment/implementation described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method, comprising:
sending, by a first network node to a second network node, information associated with an integrated access and backhaul (IAB) related migration.

2. The method of claim 1, comprising one of:
sending, by the first network node comprising a first IAB donor, to the second network node comprising a second IAB donor, the information; or
sending, by the first network node comprising an IAB node, to the second network node comprising the second IAB donor, the information.

3. The method of claim 2, wherein the information comprises at least one of:
an identity of the IAB node,
an identity of a target donor,
an identity of a target cell,
an indication of IAB mobile termination (IAB-MT) migration,
an indication of IAB distributed unit (IAB-DU) migration, or
an indication of user equipment (UE) migration.

4. The method of claim 1, comprising one of:
sending, by the first network node comprising an IAB node, to the second network node comprising a second IAB donor, the information; or
sending, by the first network node comprising a first IAB donor, to the second network node comprising the second IAB donor, the information; or
sending, by the first network node comprising a target donor, to the second network node comprising a source donor, the information;
wherein the source donor sends the information to an initial donor.

5. The method of claim 4, wherein the information comprises an old or source cell identifier (ID) of a distributed unit (DU) of the IAB node, and a new or target cell ID of the DU.

6. A method, comprising:
receiving, by a second network node from a first network node, information associated with an integrated access and backhaul (IAB) related migration.

7. The method of claim 6, comprising one of:
receiving, by the second network node comprising a second IAB donor, to the first network node comprising a first IAB donor, the information; or
receiving, by the second network node comprising the second IAB donor, to the first network node comprising an IAB node, the information.

8. The method of claim 7, wherein the information comprises at least one of:
an identity of the IAB node,
an identity of a target donor,
an identity of a target cell,
an indication of IAB mobile termination (IAB-MT) migration,
an indication of IAB distributed unit (IAB-DU) migration, or
an indication of user equipment (UE) migration.

9. The method of claim 6, comprising one of:
receiving, by the second network node comprising a second IAB donor, to the first network node comprising an IAB node, the information; or
receiving, by the second network node comprising the second IAB donor, to the first network node comprising a first IAB donor, the information; or
receiving, by the second network node comprising a source donor, to the first network node comprising a target donor, the information;
wherein the source donor sends the information to an initial donor.

10. The method of claim 9, wherein the information comprises an old or source cell identifier (ID) of a distributed unit (DU) of the IAB node, and a new or target cell ID of the DU.

11. A first network node, comprising:
at least one processor configured to:
send, via a transmitter to a second network node, information associated with an integrated access and backhaul (IAB) related migration.

12. The first network node of claim 11, wherein the at least one processor is configured to:
send, via the transmitter of the first network node comprising a first IAB donor, to the second network node comprising a second IAB donor, the information; or
sending, via the transmitter of the first network node comprising an IAB node, to the second network node comprising the second IAB donor, the information.

13. The first network node of claim 12, wherein the information comprises at least one of:
an identity of the IAB node,
an identity of a target donor,
an identity of a target cell,
an indication of IAB mobile termination (IAB-MT) migration,
an indication of IAB distributed unit (IAB-DU) migration, or
an indication of user equipment (UE) migration.

14. The first network node of claim 11, wherein the at least one processor is configured to:
send, via the transmitter of the first network node comprising an IAB node, to the second network node comprising a second IAB donor, the information; or
send, via the transmitter of the first network node comprising a first IAB donor, to the second network node comprising the second IAB donor, the information; or
send, via the transmitter of the first network node comprising a target donor, to the second network node comprising a source donor, the information;
wherein the source donor sends the information to an initial donor.

15. The first network node of claim 14, wherein the information comprises an old or source cell identifier (ID) of a distributed unit (DU) of the IAB node, and a new or target cell ID of the DU.

16. A second network node, comprising:
at least one processor configured to:
receive, via a receiver from a first network node, information associated with an integrated access and backhaul (IAB) related migration.

17. The second network node of claim 16, wherein the at least one processor is configured to:
receive, via the receiver of the second network node comprising a second IAB donor, to the first network node comprising a first IAB donor, the information; or
receive, via the receiver of the second network node comprising the second IAB donor, to the first network node comprising an IAB node, the information.

18. The second network node of claim 17, wherein the information comprises at least one of:
an identity of the IAB node,
an identity of a target donor,
an identity of a target cell,
an indication of IAB mobile termination (IAB-MT) migration,
an indication of IAB distributed unit (IAB-DU) migration, or
an indication of user equipment (UE) migration.

19. The second network node of claim 16, wherein the at least one processor is configured to:
receive, via the receiver of the second network node comprising a second IAB donor, to the first network node comprising an IAB node, the information; or
receive, via the receiver of the second network node comprising the second IAB donor, to the first network node comprising a first IAB donor, the information; or
receive, via the receiver of the second network node comprising a source donor, to the first network node comprising a target donor, the information;
wherein the source donor sends the information to an initial donor.

20. The second network node of claim 19, wherein the information comprises an old or source cell identifier (ID) of a distributed unit (DU) of the IAB node, and a new or target cell ID of the DU.
